(19) United States
(12) Patent Application Publication
(10) Pub. No.: US 2024/0292296 A1
(43) Pub. Date: Aug. 29, 2024

(54) DEVICE TO NETWORK RELAY

(71) Applicant: Nokia Technologies Oy, Espoo (FI)

(72) Inventors: Alperen GUNDOGAN, Munich (DE); Berthold PANZNER, Munich (DE); Ingo VIERING, Munich (DE); Ahmad AWADA, Munich (DE)

(21) Appl. No.: 18/570,911

(22) PCT Filed: Jun. 17, 2021
(86) PCT No.: PCT/EP2021/066445

§ 371 Date: Dec. 15, 2023

(51) Int. Cl. H04W 36/00; H04W 36/36

(52) U.S. Cl. CPC H04W 36/033; H04W 36/0061; H04W 36/362

(57) ABSTRACT

When an apparatus, which has a direct connection to a serving cell in a wireless network and a sidelink connection to a relaying apparatus at least via which data is relayed between the apparatus and the serving cell, detects a mobility event relating to the direct connection, the apparatus determines for the mobility event a target cell in the wireless network; and causes transmitting over the sidelink connection to the relaying apparatus a control signal message to be relayed to the serving cell, the control signal message indicating at least the mobility event, the target cell and an identifier of the apparatus.

### TECHNICAL FIELD

Various example embodiments relate to wireless communications.

### BACKGROUND

Wireless communication systems are under constant development. One way to increase network coverage is to use so called device-to-network relay technology in which sidelink communication is used, for example to receive data at a device from the network relayed via another device or transmit data from a device to another device, which then relays the data to a network.

### BRIEF DESCRIPTION

The scope of protection sought for various embodiments of the invention is set out by the independent claims. The embodiments, examples and features, if any, described in this specification that do not fall under the scope of the independent claims are to be interpreted as examples useful for understanding various embodiments of the invention.

An aspect provides an apparatus comprising at least one processor; and at least one memory including computer program code, the at least one memory and computer program code being configured to, with the at least one processor, cause the apparatus at least to perform: establishing a direct connection to a serving cell in a wireless network; establishing a sidelink connection to a relaying apparatus at least via which data is relayed between the apparatus and the serving cell; detecting a mobility event relating to the direct connection; determining for the mobility event a target cell in the wireless network; and causing transmitting over the sidelink connection to the relaying apparatus a control signal message to be relayed to the serving cell, the control signal message indicating at least the mobility event, the target cell and an identifier of the apparatus.

In an embodiment, the at least one memory and computer program code are configured to, with the at least one processor, cause the apparatus further to perform, before causing transmitting the control signal message to the relaying apparatus: adding information indicating the serving cell to the control signal message.

In an embodiment, the at least one memory and computer program code are configured to, with the at least one processor, cause the apparatus further to perform, before adding the information indicating the serving cell: determining, whether the relaying apparatus is served by the serving cell; and performing the adding in response to determining that the relaying apparatus is not served by the serving cell.

In embodiments, the at least one memory and computer program code are configured to, with the at least one processor, cause the apparatus further to perform: detecting as the mobility event that a conditional handover execution condition for the target cell is met; and indicating in the control signal message that the mobility event is a conditional handover.

In embodiments, the at least one memory and computer program code are configured to, with the at least one processor, cause the apparatus further to at least perform: detecting as the mobility event a beam link failure of the direct connection; initiating a beam link failure recovery to a candidate beam; determining a cell providing the candidate beam to be the target cell; and indicating in the control signal message that the mobility event is a beam link failure.

In embodiments, the control signal message is a containerized control message transmitted to the relaying apparatus within a radio resource control reconfiguration sidelink message.

An aspect provides an apparatus comprising at least one processor; and at least one memory including computer program code, the at least one memory and computer program code being configured to, with the at least one processor, cause the apparatus at least to perform: establishing a sidelink connection to a remote apparatus; establishing to a serving wireless network a wireless connection with a relay context for the apparatus to act as a relay node to relay data between the serving wireless network and the remote apparatus using the sidelink connection between the apparatus and the remote apparatus; receiving from the remote apparatus a control signal message; and relaying the control signal message to the serving wireless network.

In an embodiment, the at least one memory and computer program code are configured to, with the at least one processor, cause the apparatus further to at least perform: receiving the control signal message within a radio resource control reconfiguration sidelink message as a containerized control message; and relaying the containerized control message within a sidelink information message.

An aspect provides a network apparatus comprising at least one processor; and at least one memory including computer program code, the at least one memory and computer program code configured to, with the at least one processor, cause the apparatus at least to perform: establishing a direct connection to an apparatus in a wireless network; establishing via at least a relaying apparatus a second connection to the apparatus with a relay context for the relaying apparatus to act as a relay node to relay data between the network apparatus and the apparatus using a sidelink connection between the relaying apparatus and the apparatus; receiving over the second connection a control signal message indicating at least a mobility event relating to the direct connection, a target cell and an identifier of the apparatus; and stopping, in response to the control signal message, at least transmitting data over the direct connection to the apparatus.

In an embodiment, the at least one memory and computer program code are configured to, with the at least one processor, cause the apparatus further to at least perform, in response to the mobility event indicated being a conditional handover: stopping receiving data over the direct connection from the apparatus; causing transmitting to a target network apparatus providing the target cell information for receiving data from the apparatus and for transmitting data to the apparatus; forwarding to the target network apparatus data to be transmitted to the apparatus; and causing transmitting to one or more network apparatuses that provide one or more cells that have been determined to be a candidate cell for the conditional handover information indicating to release resources allocated for the apparatus.

In embodiments, the at least one memory and computer program code are configured to, with the at least one processor, cause the apparatus further to at least perform, in response to the mobility event indicated being a beam link failure: determine, whether the network apparatus provides the target cell indicated, storing, in response to the network apparatus providing the target cell, temporarily data to be transmitted to the apparatus until a beam recovery process ends; and performing, in response to the network apparatus not providing the target cell indicated, following: causing transmitting to a target network apparatus providing the target cell indicated information for receiving data from the apparatus and for transmitting data to the apparatus; forwarding to the target network apparatus data to be transmitted to the apparatus; and releasing resources allocated for the apparatus.

An aspect provides an apparatus comprising means for performing at least: establishing a direct connection to a serving cell in a wireless network; establishing a sidelink connection to a relaying apparatus at least via which data is relayed between the apparatus and the serving cell; detecting a mobility event relating to the direct connection; determining for the mobility event a target cell in the wireless network; and causing transmitting over the sidelink connection to the relaying apparatus a control signal message to be relayed to the serving cell, the control signal message indicating at least the mobility event, the target cell and an identifier of the apparatus.

An aspect provides an apparatus comprising means for performing at least: establishing a sidelink connection to a remote apparatus; establishing to a serving wireless network a wireless connection with a relay context for the apparatus to act as a relay node to relay data between the serving wireless network and the remote apparatus using the sidelink connection between the apparatus and the remote apparatus; receiving from the remote apparatus a control signal message; and relaying the control signal message to the serving wireless network.

An aspect provides a network apparatus comprising means for performing at least: establishing a direct connection to an apparatus in a wireless network; establishing via at least a relaying apparatus a second connection to the apparatus with a relay context for the relaying apparatus to act as a relay node to relay data between the network apparatus and the apparatus using a sidelink connection between the relaying apparatus and the apparatus; receiving over the second connection a control signal message indicating at least a mobility event relating to the direct connection, a target cell and an identifier of the apparatus; and stopping, in response to the control signal message, at least transmitting data over the direct connection to the apparatus.

An aspect provides a method for an apparatus, the method comprising at least: establishing a direct connection to a serving cell in a wireless network; establishing a sidelink connection to a relaying apparatus at least via which data is relayed between the apparatus and the serving cell; detecting a mobility event relating to the direct connection; determining for the mobility event a target cell in the wireless network; and transmitting over the sidelink connection to the relaying apparatus a control signal message to be relayed to the serving cell, the control signal message indicating at least the mobility event, the target cell and an identifier of the apparatus.

An aspect provides a method for an apparatus, the method comprising at least: establishing a sidelink connection to a remote apparatus; establishing to a serving wireless network a wireless connection with a relay context for the apparatus to act as a relay node to relay data between the serving wireless network and the remote apparatus using the sidelink connection between the apparatus and the remote apparatus; receiving from the remote apparatus a control signal message; and relaying the control signal message to the serving wireless network.

An aspect provides a method for a network apparatus, the method comprising at least: establishing a direct connection to an apparatus in a wireless network; establishing via at least a relaying apparatus a second connection to the apparatus with a relay context for the relaying apparatus to act as a relay node to relay data between the network apparatus and the apparatus using a sidelink connection between the relaying apparatus and the apparatus; receiving over the second connection a control signal message indicating at least a mobility event relating to the direct connection, a target cell and an identifier of the apparatus; and stopping, in response to the control signal message, at least transmitting data over the direct connection to the apparatus.

An aspect provides a computer readable medium comprising program instructions for causing an apparatus to perform at least the following: establishing a direct connection to a serving cell in a wireless network; establishing a sidelink connection to a relaying apparatus at least via which data is relayed between the apparatus and the serving cell; detecting a mobility event relating to the direct connection; determining for the mobility event a target cell in the wireless network; and causing transmitting over the sidelink connection to the relaying apparatus a control signal message to be relayed to the serving cell, the control signal message indicating at least the mobility event, the target cell and an identifier of the apparatus.

An aspect provides a computer readable medium comprising program instructions for causing an apparatus to perform at least the following: establishing a sidelink connection to a remote apparatus; establishing to a serving wireless network a wireless connection with a relay context for the apparatus to act as a relay node to relay data between the serving wireless network and the remote apparatus using the sidelink connection between the apparatus and the remote apparatus; receiving from the remote apparatus a control signal message; and relaying the control signal message to the serving wireless network.

An aspect provides a computer readable medium comprising program instructions for causing an apparatus to perform at least the following: establishing a direct connection to a second apparatus in a wireless network; establishing via at least a relaying apparatus a second connection to the second apparatus with a relay context for the relaying apparatus to act as a relay node to relay data between the apparatus and the second apparatus using a sidelink connection between the relaying apparatus and the second apparatus; receiving over the second connection a control signal message indicating at least a mobility event relating to the direct connection, a target cell and an identifier of the second apparatus; and stopping, in response to the control signal message, at least transmitting data over the direct connection to the second apparatus.

In embodiments, the computer-readable medium is a non-transitory computer-readable medium.

An aspect provides a non-transitory computer readable medium comprising program instructions for causing an apparatus to perform at least the following: establishing a direct connection to a serving cell in a wireless network; establishing a sidelink connection to a relaying apparatus at least via which data is relayed between the apparatus and the serving cell; detecting a mobility event relating to the direct connection; determining for the mobility event a target cell in the wireless network; and causing transmitting over the sidelink connection to the relaying apparatus a control signal message to be relayed to the serving cell, the control signal message indicating at least the mobility event, the target cell and an identifier of the apparatus.

An aspect provides a non-transitory computer readable medium comprising program instructions for causing an apparatus to perform at least the following: establishing a sidelink connection to a remote apparatus; establishing to a serving wireless network a wireless connection with a relay context for the apparatus to act as a relay node to relay data between the serving wireless network and the remote apparatus using the sidelink connection between the apparatus and the remote apparatus; receiving from the remote apparatus a control signal message; and relaying the control signal message to the serving wireless network.

An aspect provides a non-transitory computer readable medium comprising program instructions for causing an apparatus to perform at least the following: establishing a direct connection to a second apparatus in a wireless network; establishing via at least a relaying apparatus a second connection to the second apparatus with a relay context for the relaying apparatus to act as a relay node to relay data between the apparatus and the second apparatus using a sidelink connection between the relaying apparatus and the second apparatus; receiving over the second connection a control signal message indicating at least a mobility event relating to the direct connection, a target cell and an identifier of the second apparatus; and stopping, in response to the control signal message, at least transmitting data over the direct connection to the second apparatus.

An aspect provides a computer program comprising instructions which, when the program is executed by an apparatus, cause the apparatus to carry out at least: establishing a direct connection to a serving cell in a wireless network; establishing a sidelink connection to a relaying apparatus at least via which data is relayed between the apparatus and the serving cell; detecting a mobility event relating to the direct connection; determining for the mobility event a target cell in the wireless network; and transmitting over the sidelink connection to the relaying apparatus a control signal message to be relayed to the serving cell, the control signal message indicating at least the mobility event, the target cell and an identifier of the apparatus.

An aspect provides a computer program comprising instructions which, when the program is executed by an apparatus, cause the apparatus to carry out at least: establishing a sidelink connection to a remote apparatus; establishing to a serving wireless network a wireless connection with a relay context for the apparatus to act as a relay node to relay data between the serving wireless network and the remote apparatus using the sidelink connection between the apparatus and the remote apparatus; receiving from the remote apparatus a control signal message; and relaying the control signal message to the serving wireless network.

An aspect provides a computer program comprising instructions which, when the program is executed by a first apparatus, cause the first apparatus to carry out at least: establishing a direct connection to a second apparatus in a wireless network; establishing via at least a relaying apparatus a second connection to the second apparatus with a relay context for the relaying apparatus to act as a relay node to relay data between the first apparatus and the second apparatus using a sidelink connection between the relaying apparatus and the second apparatus; receiving over the second connection a control signal message indicating at least a mobility event relating to the direct connection, a target cell and an identifier of the second apparatus; and stopping, in response to the control signal message, at least transmitting data over the direct connection to the second apparatus.

### BRIEF DESCRIPTION OF DRAWINGS

Embodiments are described below, by way of example only, with reference to the accompanying drawings, in which

FIG. 1 illustrates an exemplified wireless communication system;

FIG. 2 illustrates an exemplified sidelink usage situation;

FIGS. 3 to 7 are flow charts illustrating different examples of functionalities;

FIGS. 8 to 10 illustrate different examples of information exchange; and

FIGS. 11 and 12 are schematic block diagrams.

### DETAILED DESCRIPTION OF SOME EMBODIMENTS

The following embodiments are examples. Although the specification may refer to “an”, “one”, or “some” embodiment(s) in several locations, this does not necessarily mean that each such reference is to the same embodiment(s), or that the feature only applies to a single embodiment. Single features of different embodiments may also be combined to provide other embodiments. Furthermore, words “comprising” and “including” should be understood as not limiting the described embodiments to consist of only those features that have been mentioned and such embodiments may contain also features/structures that have not been specifically mentioned. Further, although terms including ordinal numbers, such as “first”, “second”, etc., may be used for describing various elements, the structural elements are not restricted by the terms. The terms are used merely for the purpose of distinguishing an element from other elements. For example, a first element could be termed a second element, and similarly, a second element could be also termed a first element without departing from the scope of the present disclosure.

Embodiments and examples described herein may be implemented in any communications system comprising wireless connection(s). In the following, different exemplifying embodiments will be described using, as an example of an access architecture to which the embodiments may be applied, a radio access architecture based on new radio (NR, 5G) or long term evolution advanced (LTE Advanced, LTE-A), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are the universal mobile telecommunications system (UMTS) radio access network (UTRAN or E-UTRAN), long term evolution (LTE, the same as E-UTRA), beyond 5G, wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

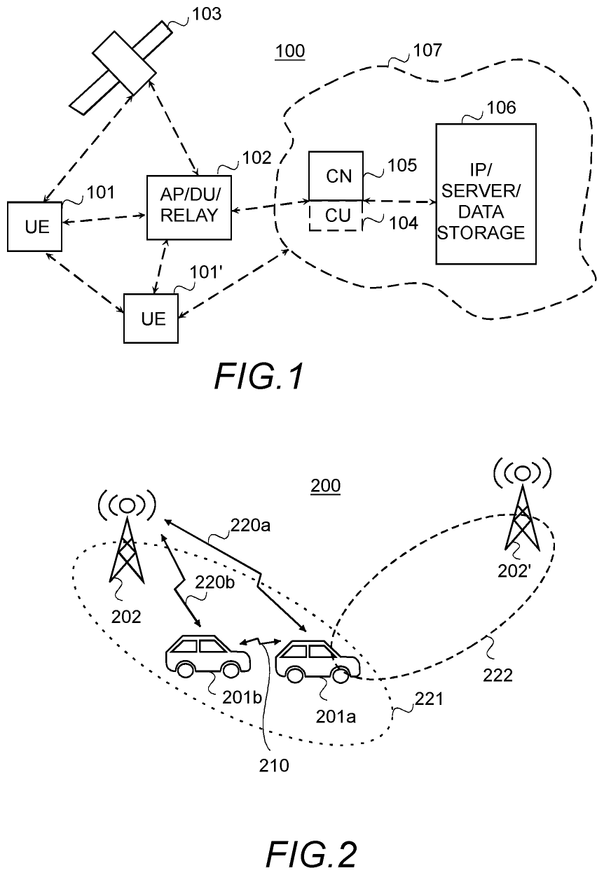

FIG. 1 depicts examples of simplified system architectures only showing some elements and functional entities, all being logical units, whose implementation may differ from what is shown. The connections shown in FIG. 1 are logical connections; the actual physical connections may be different. It is apparent to a person skilled in the art that the system typically comprises also other functions and structures than those shown in FIG. 1.

The embodiments are not, however, restricted to the system given as an example but a person skilled in the art may apply the solution to other communication systems provided with necessary properties.

The example of FIG. 1 shows a part of an exemplifying radio access network.

FIG. 1 shows user devices 101 and 101′ configured to be in a wireless connection on one or more communication channels in a cell with an access node (such as (e/g)NodeB) 102 providing the cell. The physical link from a user device to a (e/g) NodeB is called uplink or reverse link and the physical link from the (e/g)NodeB to the user device is called downlink or forward link. It should be appreciated that (e/g)NodeBs or their functionalities may be implemented by using any node, host, server or access point (AP) etc. entity suitable for such a usage. A communications system 100 typically comprises more than one (e/g) NodeB in which case the (e/g) NodeBs may also be configured to communicate with one another over links, wired or wireless, designed for the purpose. These links may be used for signaling purposes. The (e/g)NodeB is a computing device configured to control the radio resources of communication system it is coupled to. The NodeB may also be referred to as a base station, an access point or any other type of interfacing device including a relay station capable of operating in a wireless environment. The (e/g) NodeB includes or is coupled to transceivers. From the transceivers of the (e/g)NodeB, a connection is provided to an antenna unit that establishes bi-directional radio links to user devices. The antenna unit may comprise a plurality of antennas or antenna elements. The (e/g)NodeB is further connected to core network 105 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), access and mobility management function (AMF), etc.

The user device (also called UE, user equipment, user terminal, terminal device, etc.) illustrates one type of an apparatus to which resources on the air interface are allocated and assigned, and thus any feature described herein with a user device may be implemented with a corresponding apparatus.

The user device typically refers to a portable computing device that includes wireless mobile communication devices operating with a subscription entity, for example a subscriber identification module (SIM), including, but not limited to, the following types of wireless devices: a mobile station (mobile phone), smartphone, personal digital assistant (PDA), handset, device using a wireless mo-dem (alarm or measurement device, etc.), laptop and/or touch screen computer, tablet, game console, notebook, wearable device, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction. The user device may also utilise cloud. In some applications, a user device may comprise a small portable device with radio parts (such as a watch, earphones or eyeglasses) and the computation is carried out in the cloud. The user device is configured to perform one or more of user equipment functionalities. The user device may also be called a subscriber unit, mobile station, remote terminal, access terminal, user terminal or user equipment (UE) just to mention but a few names or apparatuses.

Various techniques described herein may also be applied to a cyber-physical system (CPS) (a system of collaborating computational elements control-ling physical entities). CPS may enable the implementation and exploitation of massive amounts of interconnected ICT devices (sensors, actuators, processors micro-controllers, etc.) embedded in physical objects at different locations. Mobile cyber physical systems, in which the physical system in question has inherent mobility, are a subcategory of cyber-physical systems. Examples of mobile physical systems include mobile robotics and electronics transported by humans or animals.

Additionally, although the apparatuses have been depicted as single entities, different units, processors and/or memory units (not all shown in FIG. 1) may be implemented.

5G enables using multiple input-multiple output (MIMO) antennas, many more base stations or nodes or corresponding network devices than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, augmented reality, different ways of data sharing and various forms of machine type applications (such as (massive) machine-type communications (mMTC), including vehicular safety, different sensors and real-time control. 5G is expected to have multiple radio interfaces, namely below 6 GHz, cmWave and mmWave, and also being integradable with existing legacy radio access technologies, such as the LTE. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (in-ter-radio interface operability, such as below 6 GHz-cmWave, below 6 GHZ-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The current architecture in LTE networks is fully distributed in the radio and fully centralized in the core network. The low latency applications and services in 5G require to bring the content close to the radio which leads to local break out and multi-access edge computing (MEC). 5G enables analytics and knowledge generation to occur at the source of the data. This approach requires leveraging resources that may not be continuously connected to a network such as laptops, smartphones, tablets and sensors. MEC provides a distributed computing environment for application and service hosting. It also has the ability to store and process content in close proximity to cellular subscribers for faster response time. Edge computing covers a wide range of technologies such as wireless sensor networks, mobile data acquisition, mobile signature analysis, cooperative distributed peer-to-peer ad hoc networking and processing also classifiable as local cloud/fog computing and grid/mesh computing, dew computing, mobile edge computing, cloud-let, distributed data storage and retrieval, autonomic self-healing networks, remote cloud services, augmented and virtual reality, data caching, Internet of Things (massive connectivity and/or latency critical), critical communications (autonomous vehicles, traffic safety, real-time analytics, time-critical control, healthcare applications).

The communication system is also able to communicate with other networks, such as a public switched telephone network or the Internet 106, or utilise services provided by them. The communication network may also be able to support the usage of cloud services, for example at least part of core network operations may be carried out as a cloud service (this is depicted in FIG. 1 by “cloud” 107). The communication system may also comprise a central control entity, or a like, providing facilities for networks of different operators to cooperate for example in spectrum sharing.

Edge cloud may be brought into radio access network (RAN) by utilizing network function virtualization (NVF) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 102) and non-real time functions being carried out in a centralized manner (in a centralized unit, CU 104).

It should also be understood that the distribution of labour between core network operations and base station operations may differ from that of the LTE or even be non-existent. Some other technology advancements probably to be used are Big Data and all-IP, which may change the way networks are being constructed and managed. 5G (or new radio, NR) networks are being designed to support multiple hierarchies, where MEC servers can be placed between the core and the base station or nodeB (gNB). It should be appreciated that MEC can be applied in 4G networks as well.

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano)satellites are deployed). Each satellite 103 in the mega-constellation may cover several satellite-enabled network entities that create on-ground cells. The on-ground cells may be created through an on-ground relay node 102 or by a gNB located on-ground or in a satellite.

It is obvious for a person skilled in the art that the depicted system is only an example of a part of a radio access system and in practice, the system may comprise a plurality of (e/g) NodeBs, the user device may have an access to a plurality of radio cells and the system may comprise also other apparatuses, such as relay nodes, for example distributed unit (DU) parts of one or more integrated access and backhaul (IAB) nodes, or other network elements, etc. At least one of the (e/g)NodeBs or may be a Home(e/g)nodeB. Additionally, in a geographical area of a radio communication system a plurality of different kinds of radio cells as well as a plurality of radio cells may be provided. Radio cells may be macro cells (or umbrella cells) which are large cells, usually having a diameter of up to tens of kilometers, or smaller cells such as micro-, femto- or picocells. The (e/g) NodeBs of FIG. 1 may provide any kind of these cells. A cellular radio system may be implemented as a multilayer network including several kinds of cells. Typically, in multilayer networks, one access node provides one kind of a cell or cells, and thus a plurality of (e/g)NodeBs are required to provide such a network structure.

For fulfilling the need for improving the deployment and performance of communication systems, the concept of “plug-and-play” (e/g)NodeBs has been introduced. Typically, a network which is able to use “plug-and-play” (e/g)Node Bs, includes, in addition to Home (e/g)NodeBs (H(e/g)nodeBs), a home node B gateway, or HNB-GW (not shown in FIG. 1). A HNB Gateway (HNB-GW), which is typically installed within an operator's network may aggregate traffic from a large number of HNBs back to a core network.

One way to extend network coverage, for example in 3G, 4G, 5G and beyond 5G, is to use a concept called a sidelink based “user equipment to network” (UE-to-NW, device-to-network). The concept may be used, for example, in public safety services and vehicle-to-everything (V2X) services. The vehicle-to-everything services includes vehicle-to-vehicle (V2V), vehicle-to-pedestrian (V2P), and vehicle-to-infrastructure (V21), for example. For example, in vehicles the sidelink provides a mechanism to reduce accident risks and to provide a safe driving experience.

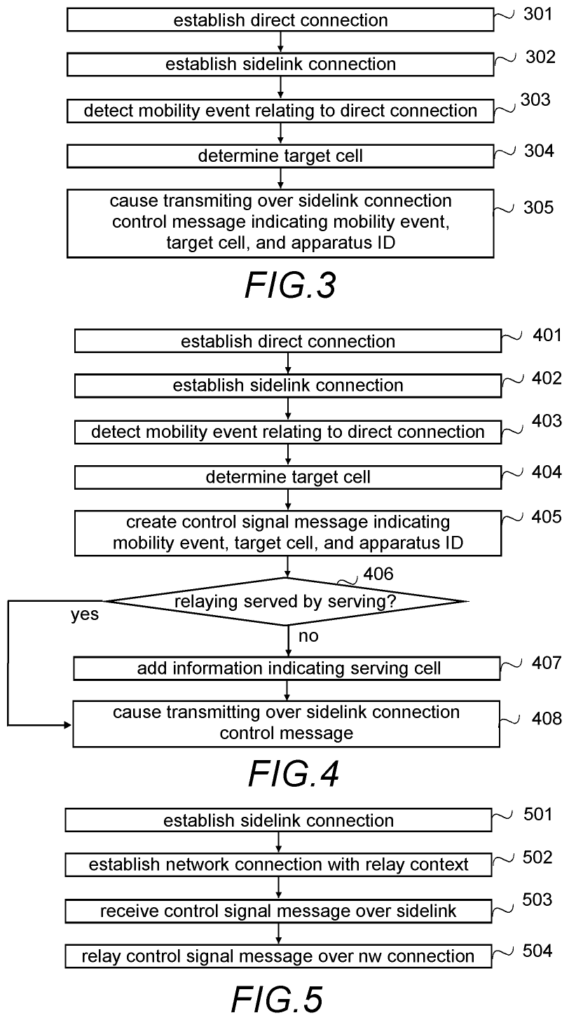

FIG. 2 provides a highly simplified example of the sidelink based “user equipment to network” relay concept in a situation in which user devices, depicted by two vehicles, are mobile and moving. It should be appreciated that the concept may be implemented to all user devices, including smart phones, sensor and wearable accessories configured to support sidelink communication.

Referring to FIG. 2, vehicles (apparatuses, devices) 201a and 201b are capable to have a wireless connection 220a, 220b to a wireless network and are configured to communicate with each other using sidelink connection 210 (direct communication, machine type communications). In the illustrated example it is assumed that one of the vehicles, vehicle 201a is remote apparatus, and the other one of the vehicles, vehicle 201b is a relaying apparatus, configured to relay traffic received from the remote apparatus 201a over the sidelink connection 210 to the wireless network over its wireless connection 220b. Even though in the illustrated example both vehicles have the wireless connection 220a, 220b to the same cell that need not to be the case. The wireless network is provided by means of base stations 202, 202′ (gNBs, access nodes, network apparatuses) via corresponding cells 221, 222, as described above with FIG. 1. It should be appreciated, even though not illustrated in FIG. 2 for the sake of clarity, that a cell may comprise a plurality of beams, wherein a wireless connection is via one beam. In 5G, at least in V2X services, the interface for the sidelink 210 is called PC5 and the interface 220a, 220b for the wireless connection to the serving wireless network (in the illustrated example to a base station) is called Uu interface.

In the illustrated example of FIG. 2, the vehicles 201a, 201b are moving (traveling), and a mobility event relating to a direct connection of the remote apparatus, i.e. the wireless connection 220a, for example, may happen. For example, when the remote apparatus (device 201a) is moving, the serving base station may prepare, based on measurement report received from the remote apparatus, one or more candidate cells for a conditional handover, and configure the remote apparatus with a conditional handover execution condition, fulfilment of which triggers the handover to one of the candidate cells as a target cell of the handover, as is known in the art. Hence there is no need to describe the details of the conditional handover in more detail herein. It may also be that when the remote apparatus (device 201a) is moving, it may detect a beam failure (a serving beam failure), for example when it moves at the edge of the serving beam. Once the remote apparatus detects the beam failure, it will initiate a beam failure recovery procedure by selecting and indicating a beam, as is known in the art. Hence there is no need to describe the details of the beam failure recovery procedure in more detail herein. In one implementation, the serving base station may send an indication to candidate cell(s) to prepare, based on measurement report received from the remote apparatus, one or more candidate beams, for example in a similar way as candidate cells are prepared.

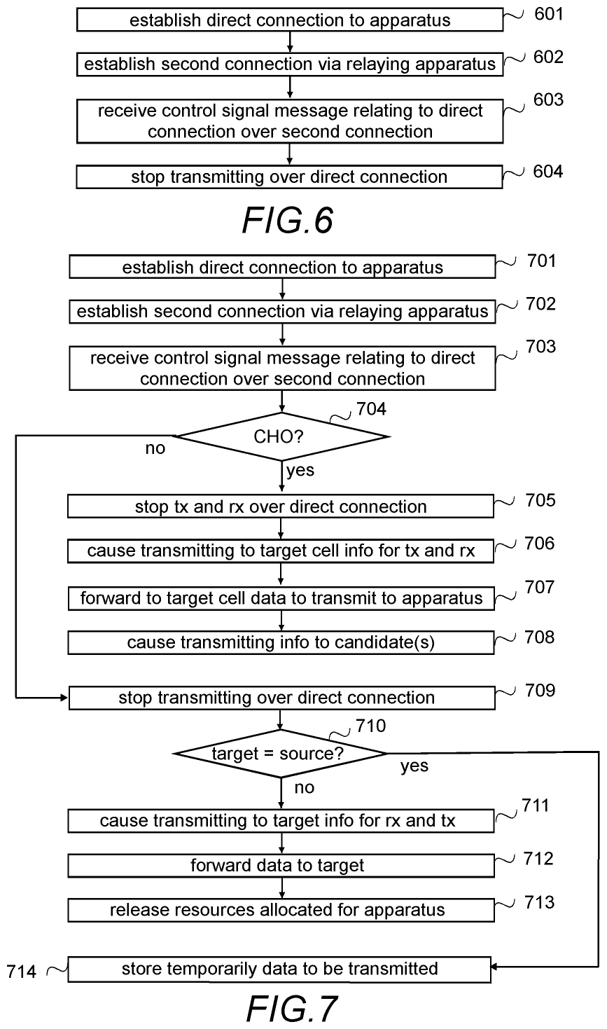

The device (vehicle), may be configured to inform, when acting as a remote apparatus, the serving cell on the mobility event, for example as described below with FIGS. 3, 4 and 8 to 10. Correspondingly, the device (vehicle), may be configured to relay, when acting a relaying apparatus, information on the mobility event, for example as described below with FIGS. 5 and 8 to 10. A network apparatus, for example the base station, may be configured to act according to received information on the mobility event, for example as described below with FIGS. 6 to 10.

Referring to FIG. 3, an apparatus establishes in block 301 a direct connection to a serving cell in a wireless network, and establishes in block 302 a sidelink connection to a relaying apparatus at least via which data is relayed between the apparatus and the serving cell. Both connection establishments are known in the art, and hence need not to be described in more detail herein. When the apparatus detects in block 303 a mobility event relating to the direct connection, the apparatus determines in block 304 for the mobility event a target cell in the wireless network; and transmitting over the sidelink connection to the relaying apparatus a control signal message to be relayed to the serving cell is caused in block 305. The control signal message indicates at least the mobility event, the target cell and an identifier of the apparatus. The indicated mobility event may be that a conditional handover execution condition for the target cell has been met, result being that a handover procedure to the target cell has been triggered. Another example of the indicated mobility event includes that a beam failure recovery process to a beam in the target cell has been started. The target cell may be indicated by adding a physical cell identifier, or corresponding information to the control signal message. The identifier of the apparatus may be indicated by adding to the control signal message a cell radio network temporary identifier, or corresponding identifier, given by the wireless network to the apparatus and known by the network apparatus providing the serving cell to the apparatus.

Referring to FIG. 4, an apparatus establishes in block 401 a direct connection to a serving cell in a wireless network, and establishes in block 402 a sidelink connection to a relaying apparatus at least via which data is relayed between the apparatus and the serving cell. Both connection establishments are known in the art, and hence need not to be described in more detail herein. When the apparatus detects in block 403 a mobility event relating to the direct connection, the apparatus determines in block 404 for the mobility event a target cell in the wireless network; and creates in block 405 a control signal message indicating the mobility event, the target cell and an identifier of the apparatus. (They may be indicated as described above with FIG. 3.)

Then the apparatus checks in block 406, whether the relaying apparatus is served by the serving cell, that serves the apparatus. If the relaying apparatus and the apparatus are served by different serving cells (block 406: no), information indicating the serving cell of the apparatus is added in block 407 to the control signal message. For example, a physical cell identifier of the serving cell may be added. By adding the information it is ensured that a cell serving the relaying apparatus knows to where forward the control signal message. Then transmitting over the sidelink connection to the relaying apparatus the control signal message to be relayed to the serving cell is caused in block 408.

If the relaying apparatus and the apparatus are served by the same serving cell (block 406: yes), the process proceed directly to block 408 to cause transmitting the control signal message over the sidelink connection.

In a still further example, based on the one described with FIG. 4, the checking of block 406 is skipped over and information indicating the serving cell of the apparatus is added to all control signal messages.

Referring to FIG. 5, an apparatus, acting as a relaying apparatus, establishes in block 501 a sidelink connection to a remote apparatus, and establishes in block 502 to a serving wireless network a wireless connection (a network connection) with a relay context for the apparatus to act as a relay node to relay data between the serving wireless network and the remote apparatus using the sidelink connection between the apparatus and the remote apparatus. Both connection establishments are known in the art, and hence need not to be described in more detail herein.

Then the apparatus receives in block 503 from the remote apparatus a control signal message over the sidelink connection. (The receiving may be a result of block 305 or block 408 described above.) For example, the control signal message may be a containerized control message transmitted to and hence received by the relaying apparatus within a radio resource control reconfiguration sidelink message. For example, a message may be an “RRCReconfigurationSidelink” message according to PC5, modified to contain in “RRCReconfigurationSidelink-IEs-rXX” a new information element “sl-ContainerizedControlMessage-rXX”, which is an optional octet string containing the control signal message as embedded, i.e. as byte container, control message. The apparatus then relays in block 504 the control signal message to the serving wireless network over the network (nw) connection. For example, the apparatus may relay the control signal message within a sidelink information message. For example, a message used in relaying may be a “Side-linkUEInformationNR-rXX” message, modified to contain in “SidelinkUEInfor-mationNR-rXX-IEs” a new information element “sl-ContainerizedControlMessage-rXX”, which is an optional octet string which is an optional octet string containing the control signal message as embedded, i.e. as byte container, control message.

Referring to FIG. 6, a network apparatus establishes in block 601 a direct connection (wireless connection) to an apparatus in a wireless network to which apparatus the network apparatus provides a serving cell. The network apparatus also establishes in block 602 via at least a relaying apparatus a second connection to the apparatus with a relay context for the relaying apparatus to act as a relay node to relay data between the network apparatus and the apparatus using a sidelink connection between the relaying apparatus and the apparatus. The relaying apparatus may be served by the network apparatus, or by another network apparatus. Both connection establishments are known in the art, and hence need not to be described in more detail herein.

Then the network apparatus receives in block 603 over the second connection a control signal message indicating at least a mobility event relating to the direct connection, a target cell and an identifier of the apparatus. The mobility event, the target cell and the identifier of the apparatus may be indicated as explained above with FIG. 3. Further, the control signal message may be received within a sidelink information message, as explained above with FIG. 5. The network apparatus stops, in block 604, in response to the control signal message, at least transmitting data over the direct connection to the apparatus. By stopping transmitting data over the direct connection to the apparatus provides efficient use of downlink resources.

Referring to FIG. 7, a network apparatus establishes in block 701 a direct connection to an apparatus in a wireless network and establishes in block 702 via at least a relaying apparatus a second connection to the apparatus with a relay context, as described in more detail with blocks 601 and 602. Then the network apparatus receives in block 703 over the second connection a control signal message indicating at least a mobility event relating to the direct connection, a target cell and an identifier of the apparatus, as described in more detail with block 603.

In the illustrated example, the network apparatus checks in block 704, whether the indicated mobility event relates to a conditional handover (CHO) or to a beam link failure.

If the mobility event relates to a conditional handover (block 704: yes), the network apparatus stops in block 705 transmitting (tx) data over the direct connection to the apparatus and receiving (rx) data over the direct connection from the apparatus. Further, transmitting to a target network apparatus providing the target cell information for receiving data from the apparatus and for transmitting data to the apparatus is caused in block 706. For example, sequence number status indicating the next missing downlink and uplink packet to be transmitted and received by the target cell may be transmitted in block 706. Further, the network apparatus forwards in block 707 to the target network apparatus data to be transmitted to the apparatus. As to the other possible candidate cells for the conditional handover, transmitting to one or more network apparatuses that provide one or more cells that have been determined to be a candidate cell for the conditional handover information indicating to release resources allocated for the apparatus is caused in block 708. Thanks to the indication, resources can be released. If the mobility event does not relate to a conditional handover (block 704: no), the mobility event relates to a beam link failure, and the network apparatus stops in block 709 transmitting (tx) data over the direct connection to the apparatus. Then the network apparatus checks in block 710 whether the target cell indicated in the control signal message is the serving cell where the beam link failure is detected, i.e. is the source cell, the serving cell being provided by the network apparatus.

If the target cell indicated is not the source cell (block 710: no), i.e. it is determined that the target cell is not provided by the network apparatus, transmitting to a target network apparatus providing the target cell indicated information for receiving (rx) data from the apparatus and for transmitting (tx) data to the apparatus is caused in block 711. For example, sequence number status indicating the next missing downlink and uplink packet to be transmitted and received by the target cell may be transmitted in block 711. Further, data to be transmitted to the apparatus is forwarded in block 712 to the target network apparatus, and then the network apparatus releases in block 713 resources allocated for the apparatus.

If the target cell indicated is the source cell (block 710: yes), i.e. it is determined that the target cell is provided by the network apparatus, the network apparatus stores in block 714 temporarily data to be transmitted to the apparatus until a beam recovery process ends. Then the temporarily stored data may be forwarded to the apparatus, as is known in the art.

In the example of FIG. 7 it is assumed that for the beam link failure no candidate network apparatuses, i.e. network apparatuses providing candidate beams, have been prepared. Should there be such candidate network apparatuses, the network apparatus would transmit to them information indicating to release resources allocated for the apparatus, for example after block 713 or after block 714.

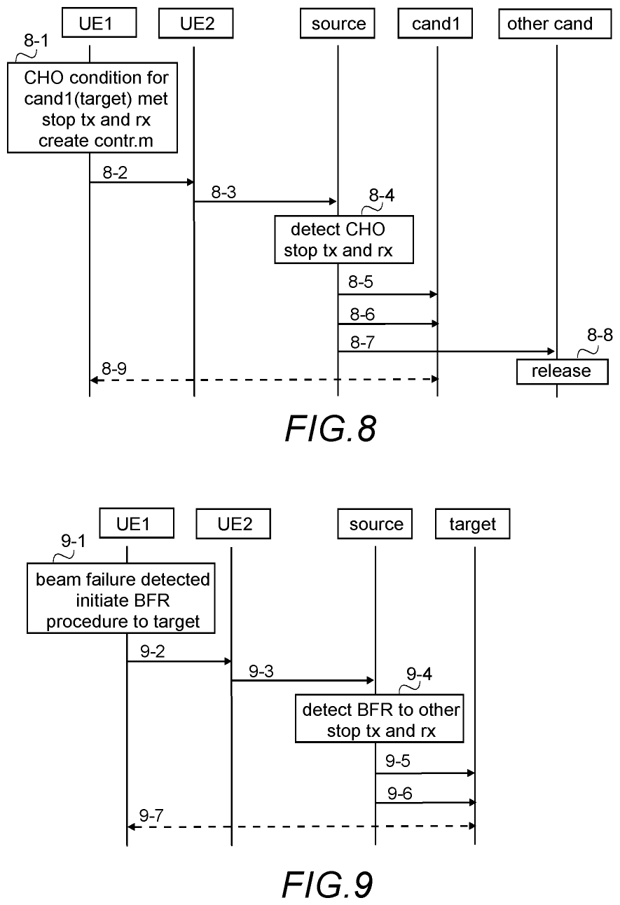

FIGS. 8 to 10 illustrate examples of information exchange. In the illustrated examples UE1 and UE2 denotes user devices, or corresponding apparatuses, UE1 an apparatus having a direct link connection to a serving cell, and a sidelink connection to UE2, which depicts a relaying apparatus. Further, a source depicts a serving network apparatus, for example a source node, providing the serving cell (source cell) to UE1. For the sake of description it is also assumed in the examples that one network apparatus provides one cell, without limiting the examples to such a solution.

In the example illustrated in FIG. 8, the source node has made, based on measurement reports from UE1, a conditional handover decision, sent/prepared one or more candidate cells (target cells) provided by corresponding candidate network apparatuses for the conditional handover of UE1, and sent a conditional handover command to UE1, the conditional handover command comprising conditional handover executions conditions. However, that is not depicted in FIG. 8.

Referring to FIG. 8, UE1 detects in block 8-1 that a conditional handover (CHO) execution condition for a candidate cell 1 (cand1) is met, and the candicate cell 1 will be a target cell for the handover. Since the condition is met, UE1 stops in block 8-1 transmitting (tx) to and receiving (rx) from, over the direct connection, the source cell, and creates a control signal message indicating conditional handover, candidate cell 1 as the target cell, and identifying information of UE1, possibly also the source cell, as described above with FIGS. 3 and 4. Then UE1 sends message 8-2 comprising the control signal message indicating the conditional handover as the mobility relating event. UE2 relays in message 8-3 the control signal indicating the conditional handover of UE1 (remote UE) as the mobility relating event UE1 to the source network apparatus (source cell).

In response to receiving the message, the source network apparatus detects in block 8-4 that a control signal message with indication of conditional handover is received. Hence, the source network apparatus is aware that UE1 will start conditional handover execution/random access procedure to the candidate cell 1. The source network apparatus stops in block 8-4, in response to said control signal message transmitting (tx) to and receiving (rx) from, over the direct connection, UE1. The source network apparatus transmits in message 8-5 information needed for receiving from and for transmitting to UE1 to the target network apparatus providing the candidate cell 1. Message 8-5 may contain sequence number (SN) status indicating the next missing downlink and uplink packet to be transmitted and received by the target cell (candidate cell 1). Further, the source network apparatus forwards (one or more message 8-6) to the target network apparatus (cand1) data targeted to UE1 and stored at the source network apparatus for transmission to UE1. The source network apparatus further informs, by transmitting one or more messages 8-7 to the one or more other candidate cells (prepared target cells), to release allocated contention free access resources for UE1. The one or more network apparatuses providing the one or more other candidate cells (candidate target cells) then release in block 8-8 the allocated resources.

UE1 starts random access procedure to the candidate cell 1 (target cell) and the handover procedure is completed, as known in the art, depicted by information exchange 8-9.

In the conventional conditional handover, in which no messages 8-2 and 8-3 are sent, blocks 8-4 and messages 8-5, 8-6 and 8-7, and block 8-8 are performed only after the handover procedure is completed, i.e. after information exchange 8-9. Hence, thanks to the control signal message transmitted using the sidelink, resources in other candidate target cells can be released earlier, and data forwarding to the target cell is started earlier, thereby enabling on-time data forwarding, which reduce an interruption time. Further, also releasing downlink resources allocated for UE1 in the source network apparatus may be performed earlier.

FIG. 9 illustrates information exchange, when a beam link failure is detected and the candidate beam is in a cell provided by another network apparatus, depicted by target in FIG. 9. In other words, a beam link failure recovery procedure is performed to a non-serving cell in the example of FIG. 9.

Referring to FIG. 9, UE1 detects in block 9-1 a beam link failure, and initiates in block 9-1 a beam link failure recovery (BFR) procedure to a target beam provided by the target network apparatus. (The target beam is one of candidate beams, selected for example based on layer 1 reference signal reception power measurements performed by UE1.)

UE1 creates a control signal message indicating beam link failure, or beam link failure recovery, the target cell, and identifying information of UE1, possibly also the source cell, as described above with FIGS. 3 and 4. Then UE1 sends message 9-2 comprising the control signal message indicating the beam link failure recovery as the mobility relating event. UE2 relays in message 9-3 the control signal indicating the beam link failure recovery of UE1 (remote UE) as the mobility relating event UE1 to the source network apparatus (source cell).

In response to receiving the message, the source network apparatus detects in block 9-4 that a control signal message with indication of beam link failure recovery is received. Hence, the source network apparatus is aware that UE1 will start random access procedure to a beam provided by the target cell (other than the serving cell, i.e. the source cell). The source network apparatus stops in block 9-4, in response to said control signal message transmitting (tx) to and receiving (rx) from, over the direct connection, UE1. The source network apparatus transmits in message 9-5 information needed for receiving from and for transmitting to UE1 to the target network apparatus providing the target cell with the beam. Message 9-5 may contain sequence number (SN) status indicating the next missing downlink and uplink packet to be transmitted and received by the target cell. Further, the source network apparatus forwards (one or more message 9-6) to the target network apparatus data targeted to UE1 and stored at the source network apparatus for transmission to UE1.

UE1 starts random access procedure to the target cell (target beam) and the beam link failure recovery procedure is completed, as known in the art, depicted by information exchange 9-7.

In the conventional beam link failure recovery procedures, in which no messages 9-2 and 9-3 are sent, block 9-4 and messages 9-5 and 9-6 are performed only after the beam link failure recovery procedure is completed, i.e. after information exchange 9-7. Hence, thanks to the control signal message transmitted using the sidelink, data forwarding to the target cell is started earlier, thereby enabling on-time data forwarding, which reduce an interruption time. Further, also releasing downlink resources allocated for UE1 in the source network apparatus may be performed earlier.

FIG. 10 illustrates information exchange, when a beam link failure is detected, the candidate beam is in the serving cell provided by the serving network apparatus (source), but the serving network apparatus has prepared, for example by forwarding user equipment context of UE1, one or more other candidate network apparatuses, depicted by other cand in FIG. 10, for a beam link failure recovery procedure. Further, in the example of FIG. 10, it is assumed that the relaying apparatus UE2 is served by another network apparatus, depicted by NA in FIG. 10, than UE1.

Referring to FIG. 10, UE1 detects in block 10-1 a beam link failure, and initiates in block 10-1 a beam link failure recovery (BFR) procedure to a target beam provided by the serving network apparatus. (The target beam is one of candidate beams, selected for example based on layer 1 reference signal reception power measurements performed by UE1.)

UE1 creates a control signal message indicating beam link failure, or beam link failure recovery, the target cell, which in the illustrated example is the source cell, identifying information of UE1, and information on the source cell, as described above with FIG. 4. Then UE1 sends message 10-2 comprising the control signal message indicating the beam link failure recovery as the mobility relating event. UE2 relays in message 10-3 the control signal indicating the beam link failure recovery of UE1 (remote UE) as the mobility relating event UE1 to its serving cell provided by NA.

NA checks in block 10-4 the indicated source in the control signal message, and forward the control signal message in message 10-5 to the indicated source.

In response to receiving message 10-5, the source network apparatus detects in block 10-6 that a control signal message with indication of beam link failure recovery is received. Hence, the source network apparatus is aware that there is a beam link failure and UE1 will start random access procedure to a beam provided by the source cell. The source network apparatus stops in block 10-6, in response to said control signal message transmitting (tx) to and receiving (rx) from, over the direct connection, UE1, and starts in block 10-6 to temporarily store data targeted to UE1. The source network apparatus further informs, by transmitting one or more messages 10-7 to the one or more other candidate cells (prepared target cells), to release allocated beam link failure recovery resources for UE1. For example, radio resources, such as guarantee bit rate bearers, or contention free random access preambles associated with candidate beams may have been allocated. The one or more network apparatuses providing the one or more other candidate cells (candidate target cells) then release in block 10-8 the allocated resources.

UE1 starts random access procedure to the target beam in the source cell and the beam link failure recovery procedure is completed, as known in the art, depicted by information exchange 10-9.

In another implementation also NA is aware of candidate cells. For example, the source network apparatus may be configured to figure out NA serving the relaying apparatus, and send information on candidate cells to NA. In the implementation, NA is configured to check in block 10-4 also the indicated target, and to inform, by transmitting one or more messages 10-7 to the one or more other candidate cells (prepared target cells), to release allocated beam link failure recovery resources for UE1. In the implementation, the source network apparatus is configured not to send messages 10-7, when the control signal message is received from NA (another network apparatus). In another implementation, UE1 can be configured to include information on other prepared candidate cell(s) to control information message to inform NA about the other prepared candidate cell(s) to enable early release of resources for prepared candidate cell(s) by NA.

In the conventional beam link failure recovery procedures, in which no messages 10-2, 10-3 (and 10-5) are sent, transmitting to UE1, and waiting for receiving transmissions from UE1 would be continued in vain, thereby wasting resources. Further, in the conventional beam link failure recovery procedure message 10-7 and block 10-8 are performed only after the beam link failure recovery procedure is completed, i.e. after information exchange 10-8. Hence, thanks to the control signal message transmitted using the sidelink, releasing resources allocated for UE1 in the candidate cells may be performed earlier.

It should be appreciated that also in the example of FIG. 9, if other candidate network apparatuses are prepared for the beam link failure recovery process, message(s) 10-7 may be sent and, correspondingly, releasing reserved resources in block 10-8 may be performed.

Further, it should be appreciated that also in the examples of FIGS. 8 and 9, if the relaying apparatus UE2 is served by another network apparatus than the remote apparatus UE1, instead of transmitting message 8-3 or 9-3 directly to the source node, message transmission is performed as depicted in FIG. 10.

The blocks, related functions, and information exchanges described above by means of FIGS. 2 to 10 are in no absolute chronological order, and some of them may be performed simultaneously or in an order differing from the given one. Other functions can also be executed between them or within them, and other information may be transmitted, and/or other rules applied or selected. Some of the blocks or part of the blocks or one or more pieces of information can also be left out or replaced by a corresponding block or part of the block or one or more pieces of information.

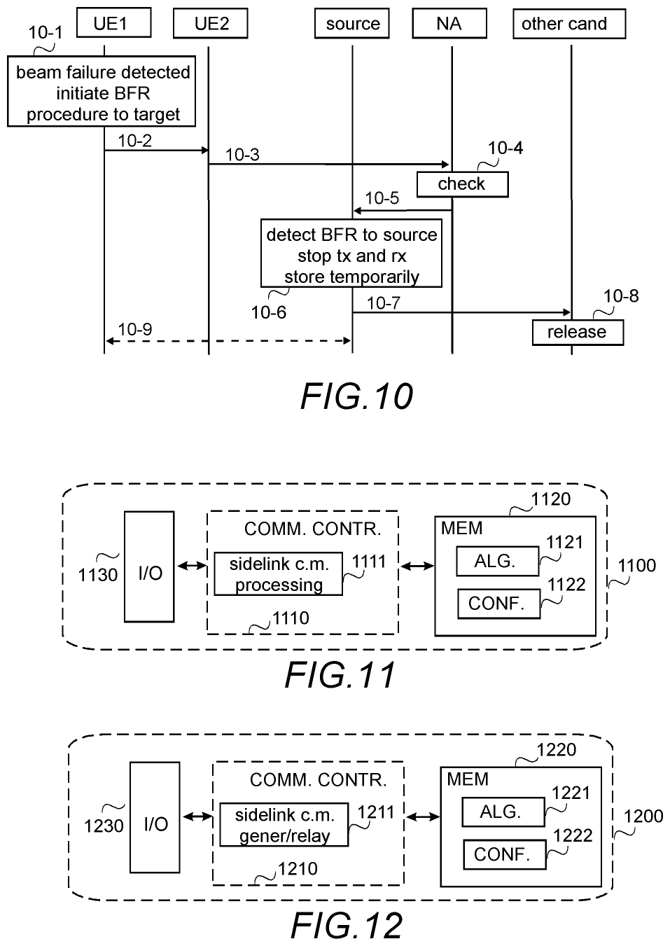

FIGS. 11 and 12 illustrate apparatuses comprising a communication controller 1110, 1210 such as at least one processor or processing circuitry, and at least one memory 1120, 1220 including a computer program code (software, algorithm) ALG. 1121, 1221, wherein the at least one memory and the computer program code (software, algorithm) are configured, with the at least one processor, to cause the respective apparatus to carry out any one of the embodiments, examples and implementations described above. FIG. 11 illustrates an apparatus configured to provide one or more cells in a wireless network, to establish direct connections with user devices and second connections with relay contexts, or any corresponding network apparatus, and FIG. 12 illustrates an apparatus configured to support sidelink connections and to act as a remote node and/or relaying node. The apparatus of FIG. 11 may be an electronic device, for example a transmission-reception point, which may be a base station or an access node, or an operational entity comprising one or more antennas in a base station, or an operational entity comprising one or more remote radio heads, or a remote antenna of a base station, or any other set of geographically co-located antennas forming one operational entity, for example an antenna array with one or more antenna elements, for one cell in the radio access network, or for a part of the one cell, in addition to example listed with FIG. 1. The apparatus of FIG. 12 may be another electronic device, for example a wearable device, a home appliance device, a smart device, like smart phone or smart screen, a vehicular device, a sensor, just to name couple of examples in addition to those listed with FIG. 1.

Referring to FIGS. 11 and 12, the memory 1120, 1220 may be implemented using any suitable data storage technology, such as semiconductor based memory devices, flash memory, magnetic memory devices and systems, optical memory devices and systems, fixed memory and removable memory. The memory may comprise a configuration storage CONF. 1121, 1221, such as a configuration database, for example for storing candidate cell information. The memory 1120, 1220 may further store other data, such as a data buffer for data waiting to be pro-cessed (including transmission).

Referring to FIG. 11, the apparatus, for example gNB, comprises a communication interface 1130 comprising hardware and/or software for realizing communication connectivity according to one or more wireless and/or wired communication protocols. The communication interface 1130 may provide the apparatus with radio communication capabilities with user devices (terminal devices, apparatuses), for example with the apparatus of FIG. 12, camping in one or more cells controlled by the apparatus, as well as communication capabilities towards a wired network.

Digital signal processing regarding transmission and reception of signals may be performed in a communication controller 1110. The communication interface may comprise standard well-known components such as an amplifier, filter, frequency-converter, (de)modulator, and encoder/decoder circuitries and one or more antennas.

The communication controller 1110 comprises a sidelink control signal message (c.m.) processing circuitry 1111 configured to detect mobility relating events or other information indicated in sidelink control signal messages and to react to the information according to any one of the embodiments/examples/implementations described above. The communication controller 1110 may control the sidelink control signal message (c.m.) processing circuitry 1111.

In an embodiment, at least some of the functionalities of the apparatus of FIG. 11 may be shared between two physically separate devices, forming one operational entity. Therefore, the apparatus may be seen to depict the operational entity comprising one or more physically separate devices for executing at least some of the processes described with the network apparatus.

Referring to FIG. 12, the apparatus 1200 may further comprise a communication interface 1230 comprising hardware and/or software for realizing communication connectivity according to one or more communication protocols. The communication interface 1230 may provide the apparatus 1200 with communication capabilities with the apparatus of FIG. 11 and communication capabilities for sidelink communications. The communication interface may comprise standard well-known analog components such as an amplifier, filter, frequency-converter and circuitries, and conversion circuitries transforming signals between analog and digital domains. Digital signal processing regarding transmission and reception of signals may be performed in a communication controller 1210.

The communication controller 1210 comprises a sidelink control signal message (c.m.) generating and/or relaying (gener/relay) processing circuitry 1211 configured to detect mobility events relating to direct connections to a wireless network and cause sending control signal messages over sidelink connections and/or configured to relay control signal messages according to any one of the embodiments/examples/implementations described above. The communication controller 1210 may control the sidelink control signal message generating and/or relaying processing circuitry 1211.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

In an embodiment, at least some of the processes described in connection with FIGS. 2 to 10 may be carried out by an apparatus comprising corresponding means for carrying out at least some of the described processes. The apparatus may comprise separate means for separate phases of a process, or means may perform several phases or the whole process. Some example means for carrying out the processes may include at least one of the following: detector, processor (including dual-core and multiple-core processors), digital signal processor, controller, receiver, transmitter, encoder, decoder, memory, RAM, ROM, software, firmware, display, user interface, display circuitry, user interface circuitry, user interface software, display software, circuit, antenna, antenna circuitry, and circuitry. In an embodiment, the at least one processor, the memory, and the computer program code form processing means or comprises one or more computer program code portions for carrying out one or more operations according to any one of the embodiments/examples/implementations described herein.

According to yet another embodiment, the apparatus carrying out the embodiments/examples comprises a circuitry including at least one processor and at least one memory including computer program code. When activated, the circuitry causes the apparatus to perform at least some of the functionalities according to any one of the embodiments/examples/implementations of FIGS. 2 to 10, or operations thereof.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the apparatuses (nodes) described herein may be rearranged and/or complemented by additional components in order to facilitate the achievements of the various aspects, etc., described with regard thereto, and they are not limited to the precise configurations set forth in the given figures, as will be appreciated by one skilled in the art.

Embodiments/examples/implementations as described may also be carried out in the form of a computer process defined by a computer program or portions thereof. Embodiments of the methods described in connection with FIGS. 2 to 10 may be carried out by executing at least one portion of a computer program comprising corresponding instructions. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example. The computer program medium may be a non-transitory medium, for example. Coding of software for carrying out the embodiments as shown and described is well within the scope of a person of ordinary skill in the art. In an embodiment, a computer-readable medium comprises said computer program.

It will be obvious to a person skilled in the art that, as technology advances, the inventive concept may be implemented in various ways. The embodiments are not limited to the exemplary embodiments described above, but may vary within the scope of the claims. Therefore, all words and expressions should be interpreted broadly, and they are intended to illustrate, not to restrict, the exemplary embodiments.

1. An apparatus comprising
at least one processor; and
at least one memory including computer program code, the at least one memory and computer program code configured to, with the at least one processor, cause the apparatus at least to perform:
establishing a direct connection to a serving cell in a wireless network;
establishing a sidelink connection to a relaying apparatus at least via which data is relayed between the apparatus and the serving cell;
detecting a mobility event relating to the direct connection;
determining for the mobility event a target cell in the wireless network; and
causing transmitting over the sidelink connection to the relaying apparatus a control signal message to be relayed to the serving cell, the control signal message indicating at least the mobility event, the target cell and an identifier of the apparatus.

2. The apparatus of claim 1, wherein the at least one memory and computer program code configured to, with the at least one processor, cause the apparatus further to perform, before causing transmitting the control signal message to the relaying apparatus:
adding information indicating the serving cell to the control signal message.

3. The apparatus of claim 2, wherein the at least one memory and computer program code configured to, with the at least one processor, cause the apparatus further to perform, before adding the information indicating the serving cell:
determining, whether the relaying apparatus is served by the serving cell; and
performing the adding in response to determining that the relaying apparatus is not served by the serving cell.

4. The apparatus of claim 1, 2 or 3 wherein the at least one memory and computer program code configured to, with the at least one processor, cause the apparatus further to perform:
detecting as the mobility event that a conditional handover execution condition for the target cell is met; and
indicating in the control signal message that the mobility event is a conditional handover.

5. The apparatus of claim 1, wherein the at least one memory and computer program code configured to, with the at least one processor, cause the apparatus further to at least perform:
detecting as the mobility event a beam link failure of the direct connection;
initiating a beam link failure recovery to a candidate beam;
determining a cell providing the candidate beam to be the target cell; and
indicating in the control signal message that the mobility event is a beam link failure.

6. The apparatus of claim 1, wherein the control signal message is a containerized control message transmitted to the relaying apparatus within a radio resource control reconfiguration sidelink message.

7. An apparatus comprising
at least one processor; and
at least one memory including computer program code, the at least one memory and computer program code configured to, with the at least one processor, cause the apparatus at least to perform:
establishing a sidelink connection to a remote apparatus;
establishing to a serving wireless network a wireless connection with a relay context for the apparatus to act as a relay node to relay data between the serving wireless network and the remote apparatus using the sidelink connection between the apparatus and the remote apparatus;
receiving from the remote apparatus a control signal message; and
relaying the control signal message to the serving wireless network.

8. The apparatus of claim 7, wherein the at least one memory and computer program code configured to, with the at least one processor, cause the apparatus further to at least perform:
receiving the control signal message within a radio resource control reconfiguration sidelink message as a containerized control message; and
relaying the containerized control message within a sidelink information message.

9. A network apparatus comprising
at least one processor; and
at least one memory including computer program code, the at least one memory and computer program code configured to, with the at least one processor, cause the apparatus at least to perform:
establishing a direct connection to an apparatus in a wireless network;
establishing via at least a relaying apparatus a second connection to the apparatus with a relay context for the relaying apparatus to act as a relay node to relay data between the network apparatus and the apparatus using a sidelink connection between the relaying apparatus and the apparatus;
receiving over the second connection a control signal message indicating at least a mobility event relating to the direct connection, a target cell and an identifier of the apparatus; and
stopping, in response to the control signal message, at least transmitting data over the direct connection to the apparatus.

10. The network apparatus of claim 9, wherein the at least one memory and computer program code configured to, with the at least one processor, cause the apparatus further to at least perform, in response to the mobility event indicated being a conditional handover:
stopping receiving data over the direct connection from the apparatus;
causing transmitting to a target network apparatus providing the target cell information for receiving data from the apparatus and for transmitting data to the apparatus;
forwarding to the target network apparatus data to be transmitted to the apparatus; and
causing transmitting to one or more network apparatuses that provide one or more cells that have been determined to be a candidate cell for the conditional handover information indicating to release resources allocated for the apparatus.

11. The network apparatus of claim 9, wherein the at least one memory and computer program code configured to, with the at least one processor, cause the apparatus further to at least perform, in response to the mobility event indicated being a beam link failure:
determine, whether the network apparatus provides the target cell indicated;
storing, in response to the network apparatus providing the target cell, temporarily data to be transmitted to the apparatus until a beam recovery process ends; and
performing, in response to the network apparatus not providing the target cell indicated, following:
causing transmitting to a target network apparatus providing the target cell indicated information for receiving data from the apparatus and for transmitting data to the apparatus;
forwarding to the target network apparatus data to be transmitted to the apparatus; and
releasing resources allocated for the apparatus.

12.-21. (canceled)
